(19) United States
(12) Patent Application Publication
(10) Pub. No.: US 2022/0229211 A1
(43) Pub. Date: Jul. 21, 2022

(54) IMAGE DETECTION DEVICE AND IMAGE DETECTION METHOD

(71) Applicant: MITUTOYO CORPORATION, Kanagawa (JP)

(72) Inventors: Aimin SHA, Kanagawa (JP); Shiro IGASAKI, Kanagawa (JP)

(73) Assignee: MITUTOYO CORPORATION, Kanagawa (JP)

(21) Appl. No.: 17/569,256

(22) Filed: Jan. 5, 2022

(30) Foreign Application Priority Data
Jan. 15, 2021 (JP) 2021-005040

(51) Int. Cl. G02B 3/14

(52) U.S. Cl. CPC G02B 3/14

(57) ABSTRACT

An image detection device includes an image detection optical system including a liquid resonant lens; an image detector configured to detect an image corresponding to a detection phase of a drive signal through the image detection optical system; a range determination unit configured to determine a first half or a second half of a cycle of the drive signal as a designated allowable range of the detection phase based on whether a phase delay shown by a variation waveform of a focus position is positive or negative; a detection phase setting unit configured to set the detection phase in the designated allowable range; and a detection control unit configured to control an image-detection timing by the image detector to a timing offset from the detection phase by an angle corresponding to the phase delay.

The entire disclosure of Japanese Patent Application No. 2021-005040 filed Jan. 15, 2021 is expressly incorporated by reference herein.

### TECHNICAL FIELD

The present invention relates to an image detection device including a liquid resonant lens and an image detection method.

### BACKGROUND ART

Some of typically known variable focal length lens devices include a liquid resonant lens (see, for instance, Patent Literature 1 (JP 2020-106480 A)). This type of variable focal length lens device, in which a drive signal is cyclically inputted to the liquid resonant lens, generates a standing wave in the liquid inside the liquid resonant lens. The liquid in the liquid resonant lens, which has concentric dense and sparse regions therein, provides refractivity as a lens with cyclically varying focal depth.

For instance, Patent Literature 1 discloses an image detection device including a liquid resonant lens. This image detection device, whose focus position with respect to an object cyclically varies in accordance with the focus depth of the liquid resonant lens, is configured to apply pulsed illumination at a predetermined phase (detection phase) of a drive signal to detect an image of the object focused at a focus position corresponding to the detection phase. Further, the image detection device measures displacement, surface profile and the like of the object by detecting a plurality of images at mutually different focus positions and calculating a height of a target portion of the object in a form of the focus position of focused one of the images of the object.

A phase delay in a variation waveform of the focus position may be caused in the above-described image detection device due to the effect of a temperature change on the liquid resonant lens.

### SUMMARY OF THE INVENTION

### Problems to be Solved by the Invention

The phase delay is reflected on the detection phase to correct the image-detection timing. Such a correction, however, may position the image-detection timing in a period close to a cycle switching point (360°) of the drive signal.

It should be noted that, in the above-described image detection device, it is desired that an image detection signal for controlling the image-detection timing (e.g. illumination signal for controlling the pulsed illumination) does not cross the border between cycles of the drive signal in order to synchronize the image-detection timing with the cycle of the drive signal. Accordingly, the image detection signal is forcibly switched off at the cycle switching point of the drive signal so that the image detection signal does not cross the border between the cycles of the drive signal.

Thus, when the image detection timing is located immediately before the cycle switching point, since the image detection signal is forcibly switched off at the cycle switching point, a pulse width of the image detection signal becomes insufficient and uneven illumination occurs, thereby failing to perform normal image detection. In contrast, when the image detection timing is located immediately after the cycle switching point, the image detection signal cannot be switched on, possibly causing failure in controlling the image-detection timing.

### Means for Solving the Problem(s)

An image detection device according to an aspect of the invention includes: an image detection optical system including a liquid resonant lens, a focus position of the image detection optical system cyclically varying in accordance with a drive signal inputted to the liquid resonant lens; an image detector configured to detect an image corresponding to a detection phase of the drive signal through the image detection optical system; a range determination unit configured to determine a first half or a second half of a cycle of the drive signal as a designated allowable range of the detection phase based on whether a phase delay shown by a variation waveform of the focus position is positive or negative; a detection phase setting unit configured to set the detection phase in the designated allowable range; and a detection control unit configured to control an image-detection timing by the image detector to a timing offset from the detection phase by an angle corresponding to the phase delay.

An image detection method according to another aspect of the invention is performed by an image detection device including: an image detection optical system including a liquid resonant lens, a focus position of the image detection optical system cyclically varying in accordance with a drive signal inputted into the liquid resonant lens; and an image detector configured to detect an image corresponding to a detection phase of the drive signal through the image detection optical system, the method including: determining a first half or a second half of a cycle of the drive signal as a designated allowable range of the detection phase based on whether a phase delay shown by a variation waveform of the focus position is positive or negative; setting the detection phase in the designated allowable range; and controlling an image-detection timing by the image detector to a timing offset from the detection phase by an angle corresponding to the phase delay.

### BRIEF EXPLANATION OF DRAWINGS

FIG. 1 is a schematic illustration showing an image detection device according to an exemplary embodiment of the invention.

FIG. 2 is a block diagram showing the image detection device according to the exemplary embodiment.

FIG. 3 is a graph showing temporal changes in each of a synchronization signal, an exposure signal, a focus position, and an illumination signal in the exemplary embodiment.

FIG. 4 is a schematic illustration showing an example of a calibration jig placed in the image detection device according to the exemplary embodiment.

FIG. 5 is a graph showing an example of calibration data acquired in the exemplary embodiment.

FIG. 6 is a flowchart showing an image detection method according to the exemplary embodiment.

FIG. 7 is a graph showing a phase delay of a variation waveform of the focus position in the exemplary embodiment.

FIG. 8 is a graph showing an example of a designated allowable range and a detection phase when a positive delay is caused in the exemplary embodiment.

FIG. 9 is a graph showing an example of the designated allowable range and the detection phase when a negative delay is caused in the exemplary embodiment.

FIG. 10 is a graph showing an example of an image-detection timing when a positive delay is caused in the exemplary embodiment.

FIG. 11 is a graph showing an example of the image-detection timing when a negative delay is caused in the exemplary embodiment.

FIG. 12 is a graph showing an example of the image-detection timing and an illumination signal when a positive delay is caused in the exemplary embodiment.

FIG. 13 is a graph showing an example of the image-detection timing and the illumination signal when a negative delay is caused in the exemplary embodiment.

FIG. 14 is a graph showing an example of the image-detection timing and the illumination signal when a positive delay is caused in a comparative example.

FIG. 15 is a graph showing an example of the image-detection timing and the illumination signal when a negative delay is caused in another comparative example.

### DESCRIPTION OF EMBODIMENT(S)

An exemplary embodiment of the invention will be described below with reference to attached drawings.

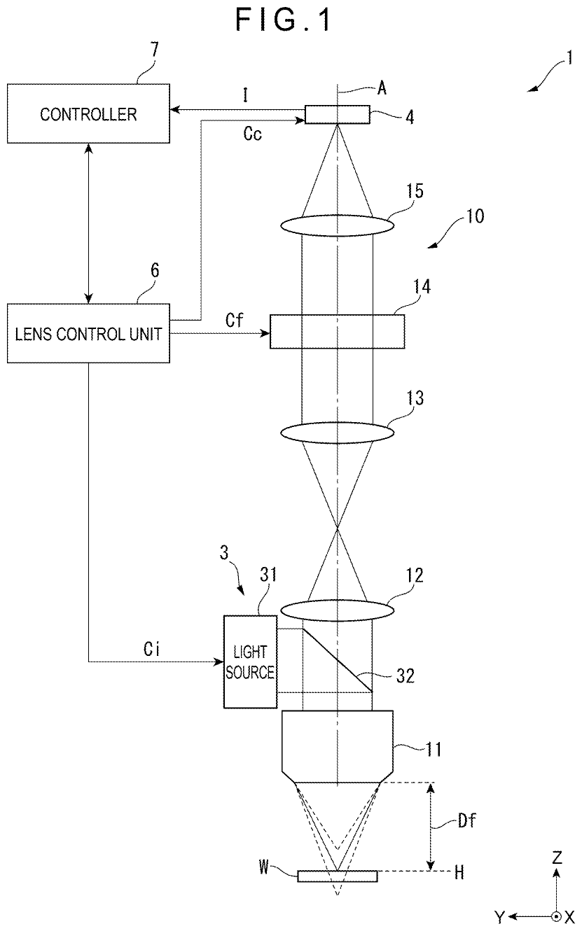

FIG. 1 schematically shows a structure of an image detection device 1 according to the present exemplary embodiment. The image detection device 1 detects an image I of a workpiece W by imaging the workpiece W through a liquid resonant lens 14 of which focal length cyclically varies.

### Arrangement of Image Detection Device 1

As shown in FIG. 1, the image detection device 1 includes an image detection optical system 10 disposed on an optical axis A intersecting a surface of the workpiece W, a pulsed light illuminator 3 configured to illuminate the workpiece W with pulsed illumination, an image capturing unit 4 configured to capture an image of the workpiece W through the image detection optical system 10, a lens control unit 6 configured to control an operation of the liquid resonant lens 14 included in the image detection optical system 10, and a controller 7 configured to operate the lens control unit 6.

The image detection optical system 10 includes an objective lens 11, an imaging lens 12, a first relay lens 13, a liquid resonant lens 14, and a second relay lens 15 arranged in this order from an object (front side).

The objective lens 11, which includes one or more lenses, is disposed to face the workpiece W. Light reflected by the workpiece W is converted into a parallel beam of light by the objective lens 11 and the parallel beam of light is incident on the imaging lens 12.

The imaging lens 12, which includes one or more lenses, is configured to concentrate the parallel beam of light entered through the objective lens 11 to form an intermediate image.

The first relay lens 13 and the second relay lens 15 are each provided by one or more lenses. The first relay lens 13 and the second relay lens 15, which form a relay system, are configured to relay the intermediate image formed by the imaging lens 12 and re-form the intermediate image on an image-capturing surface of the image capturing unit 4. It should be noted that a posterior focal point of the imaging lens 12 and an anterior focal point of the first relay lens 13 are at the same position.

The liquid resonant lens 14 is a varifocal lens. Specifically, the liquid resonant lens 14 includes a cylindrical case filled with a liquid and a cylindrical oscillator made from a piezoelectric material. The oscillator, which is connected with the lens control unit 6 via a signal line while being immersed in the liquid in the case, is configured to oscillate in accordance with a drive signal Cf (sinusoidal alternating-current signal) inputted by the lens control unit 6. When the frequency of the drive signal Cf is tuned to a resonant frequency, a standing wave is generated in the liquid inside the liquid resonant lens 14, thereby causing cyclic variation in the refractive index of the liquid.

The case of the liquid resonant lens 14 is provided with a window for passing the light therethrough. The cyclic variation in the refractive index of the liquid in the case results in cyclic variation in the focal length of the liquid resonant lens 14. The liquid resonant lens 14 thus provides cyclic variation in a focus distance Df from the objective lens 11 to a focus position H, which is primarily determined based on the focal length of the objective lens 11, in accordance with the variation in the focal length of the liquid resonant lens 14.

It should be noted that the image detection optical system 10 is provided as a telecentric optical system, where an anterior principal point of the liquid resonant lens 14 is conjugate with an exit pupil of the objective lens 11. The above-described arrangement, in which the exit pupil of the objective lens 11 is relayed in a telecentric manner, provides a constant magnification for the image incident on the image capturing unit 4 irrespective of the variation in the focus position H.

It should also be noted that an axis parallel to the optical axis A is defined as a Z axis in the present exemplary embodiment, where the focus position H is represented by a Z coordinate (Z value).

The pulsed light illuminator 3 includes a light source 31 configured to emit pulsed light and a beam splitter 32 configured to guide the pulsed light emitted by the light source 31 to the workpiece W.

The light source 31 is provided with a light-emitting element (e.g. an LED). The light source 31 is controlled by the lens control unit 6 to emit the pulsed light at a timing (image-detection timing) corresponding to a predetermined phase (detection phase θd) of the drive signal Cf.

The beam splitter 32, which is disposed between the objective lens 11 and the imaging lens 12, is configured to reflect the pulsed light emitted by the light source 31 toward the objective lens 11. The light reflected by the beam splitter 32 passes through the objective lens 11 to illuminate the workpiece W.

Further, the beam splitter 32 is configured to transmit the light reflected by the workpiece W and having passed through the objective lens 11.

The image capturing unit 4 includes any type of image sensor (e.g. an existing Charge Coupled Device (CCD) image sensor). The image capturing unit 4 is controlled by the lens control unit 6 to detect the image of the workpiece W and output the image in a form of an image I of a predetermined signal format to the controller 7.

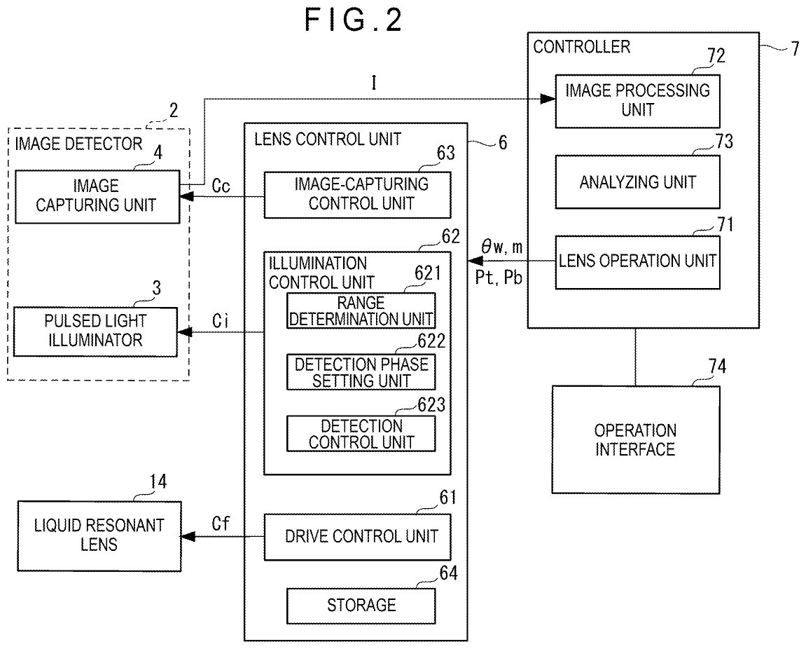

It should be noted that, in the present exemplary embodiment, the pulsed light illuminator 3 and the image capturing unit 4 form an image detector 2 for detecting the image I corresponding to the detection phase θd (see FIG. 2).

FIG. 2 shows an arrangement of the lens control unit 6 and the controller 7 according to the present exemplary embodiment.

The lens control unit 6 is a unit dedicated to controlling each of the liquid resonant lens 14, the pulsed light illuminator 3, and the image capturing unit 4. It should be noted that the lens control unit 6 may be provided by a hardware using a plurality of ICs and the like, alternatively, may be provided mainly by a computer including a storage 64 and a CPU that runs a program stored in the storage 64.

The lens control unit 6 includes a drive control unit 61 configured to control the liquid resonant lens 14, an illumination control unit 62 configured to control the pulsed light illuminator 3, an image-capturing control unit 63 configured to control the image capturing unit 4, and the storage 64.

The drive control unit 61 is configured to output the drive signal Cf to the liquid resonant lens 14 and detect an oscillation state Vf of the liquid resonant lens 14 that oscillates based on the drive signal Cf. The drive control unit 61 is configured to tune the frequency of the drive signal Cf with reference to the oscillation state Vf of the liquid resonant lens 14 to lock the frequency of the drive signal Cf at the current resonance frequency of the liquid resonant lens 14.

It should be noted that the oscillation state Vf of the liquid resonant lens 14 is detectable, specifically, by one or a combination of a drive voltage, a drive current, an effective power, which are supplied to the liquid resonant lens 14 by the drive signal Cf, and a voltage-current phase difference (i.e. a phase difference between the drive voltage and the drive current).

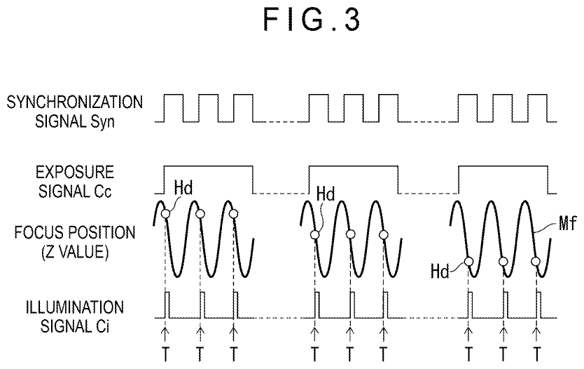

Further, the drive control unit 61 is configured to output a synchronization signal Syn, which is synchronized with the cycle of the drive signal Cf, into the lens control unit 6. The synchronization signal Syn is a pulse signal that is switched on at, for instance, a timing at which the drive signal Cf intersects 0 level (in FIG. 3, a timing for a variation waveform Mf of the focus position H to be positively peaked).

The illumination control unit 62 outputs an illumination signal Ci in a form of a pulse signal to the pulsed light illuminator 3. The illumination signal Ci is switched on at an image-detection timing T corresponding to the detection phase θd of the drive signal Cf. The pulsed light illuminator 3 emits the pulsed illumination light onto the workpiece W while the illumination signal Ci is turned on.

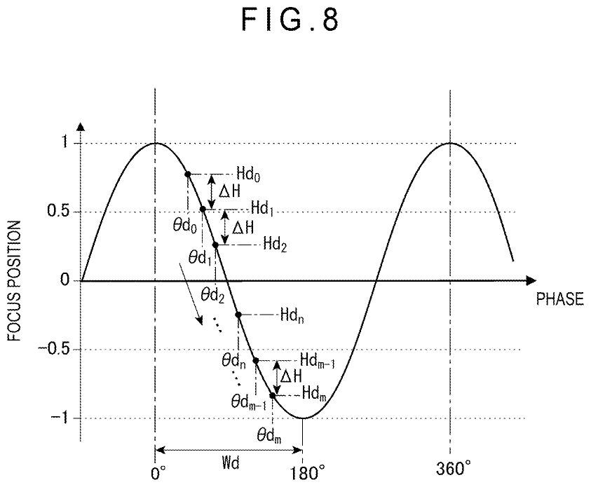

The illumination control unit 62 also includes a range determination unit 621 configured to determine a designated allowable range Wd of the detection phase θd, a detection phase setting unit 622 configured to set the detection phase θd within the designated allowable range Wd, and a detection control unit 623 configured to control the image-detection timing T based on the detection phase θd (see, for instance, FIG. 8). Details of each of the functions of the above components will be described later.

The image-capturing control unit 63 outputs an exposure signal Cc in a form of a pulse signal to the image capturing unit 4. The image capturing unit 4 is kept being exposed while the exposure signal Cc is turned on to detect the image I of the workpiece W.

As shown in FIG. 3, the illumination signal Ci is repeatedly switched on at the image-detection timing T corresponding to each of the detection phases θd of the drive signal Cf for a predetermined number of pulses of the synchronization signal Syn and the exposure signal Cc continues to be turned on over a predetermined number of pulses of the synchronization signal Syn. In other words, the pulsed light illuminator 3 applies a predetermined number of pulsed illumination while the image capturing unit 4 is kept being exposed. One frame of the image I corresponding to the detection phase θd is thus detected. The image I corresponding to the detection phase θd shows a focus state when the focus position H is at a detection focus position Hd.

It should be noted that, in the present exemplary embodiment, the illumination control unit 62 is configured to forcibly switch off the illumination signal Ci at a cycle switching point (360° or 0°) of the drive signal Cf to inhibit the illumination signal Ci from crossing the border between the cycles of the drive signal Cf.

The controller 7 shown in FIG. 2 is a device provided by a general-purpose personal computer, whose arithmetic circuit (e.g. CPU) loads and runs a dedicated software stored in a memory to achieve desired functions. Specifically, the controller 7 serves as a lens operation unit 71 configured to apply various settings to the lens control unit 6, an image processing unit 72 configured to import and process the image I from the image capturing unit 4, and an analyzing unit 73 configured to perform analysis based on the image I.

The controller 7 also includes an operation interface 74 (user interface). The operation interface 74 includes, for instance, a display unit (e.g. a monitor display) and a control unit (e.g. keyboard).

### Acquisition of Calibration Data

In the present exemplary embodiment, in preparation for the later-described image detection method, a step for acquiring calibration data is performed. The calibration data refers to data showing a correspondence relationship between the phase of the drive signal Cf and the focus position H.

It should be noted that the method for acquiring the calibration data, which is known as disclosed in a related art (see, for instance, JP 2020-106841 A), will only be briefly described hereinbelow.

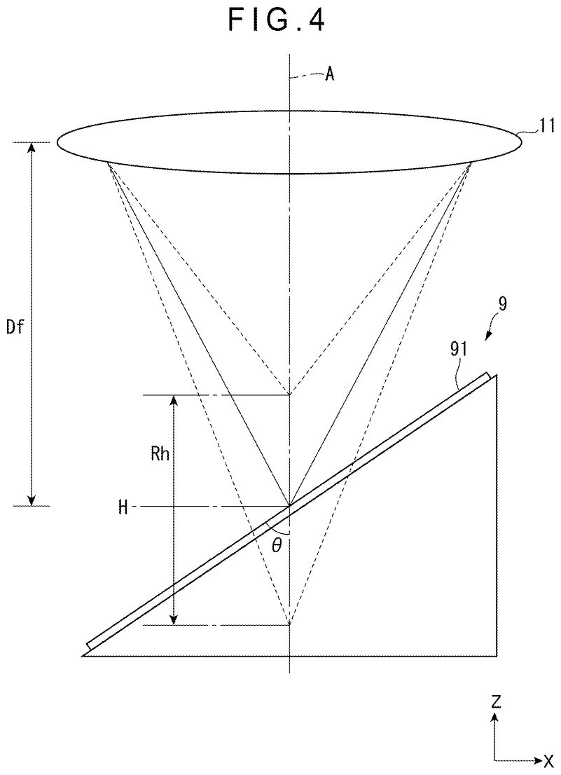

Initially, as shown in FIG. 4, a predetermined calibration jig 9 is set in an image detection area of the image detection device 1. The calibration jig 9 has a calibration surface 91 whose inclination angle A with respect to the optical axis A is known. The calibration surface 91 has a diffraction grating with a known pitch along one direction orthogonal to the Z axis (e.g. X axis).

The image detection device 1 sets detection phases θd at every 0.5° within a range (from 0° to 360°) of the phase of the drive signal Cf and detects the images I at image-detection timings T, at which the phase of the drive signal Cf reaches each of the detection phases θd. Thus, total 720 images I at mutually different focus positions H are detected.

Subsequently, the analyzing unit 73 performs analysis based on each of the images I to generate the calibration data showing a correspondence relationship between the phase of the drive signal Cf and the focus position H. Specifically, the analyzing unit 73 detects a focus area (for instance, focused grating area on the calibration surface 91) from each of the images I and calculates a Z value (i.e. the focus position H) corresponding to each of the focus areas based on the pixel coordinates of each of the focus areas, an inclination angle A of the calibration jig 9, and the like. Then, data points are plotted based on the phase of the drive signal Cf corresponding to each of the images I and the focus position H corresponding to each of the images I to calculate an approximate curve, thereby generating the calibration data.

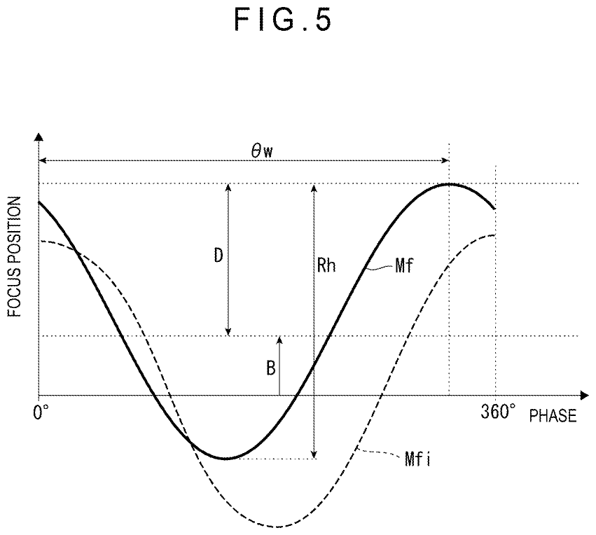

An example of the calibration data is shown by a solid line in the graph of FIG. 5. As shown by the solid line in FIG. 5, the focus position H shows the variation waveform Mf that cyclically varies in accordance with the phase of the drive signal Cf.

An ideal waveform Mfi calculated based on the drive signal Cf is shown by a dotted line in FIG. 5. The variation waveform Mf of the drive signal Cf has a certain offset with respect to the ideal waveform Mfi. This offset is commonly caused by a change in lens properties of the liquid resonant lens 14 effected by a temperature variation.

The offset of the variation waveform Mf of the drive signal Cf includes deviation B of an amplitude D.

The analyzing unit 73 calculates a variable range Rh of the focus position H based on the calibration data and corrects the deviation B by setting a midpoint of the variable range Rh at 0 value of the Z axis.

The offset of the variation waveform Mf of the drive signal Cf also includes a phase delay. Details of the phase delay will be described later. FIG. 5 shows a negative delay caused in the variation waveform Mf of the focus position H.

The analyzing unit 73 calculates a phase width θw from a cycle start phase (0°) of the drive signal Cf to a positive peak of the variation waveform Mf based on the calibration data and stores the phase width θw in a storage (not shown) of the controller 7. The phase width θw is used in the later-described image detection method in order to determine whether the phase delay of the variation waveform Mf is positive or negative.

### Image Detection Method

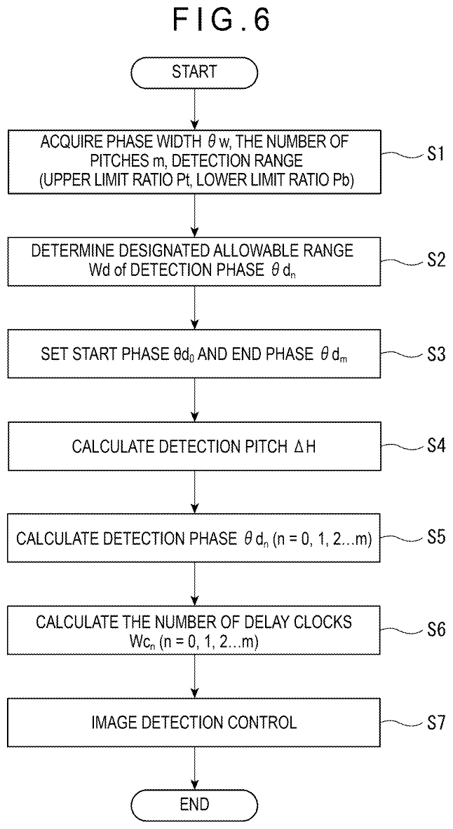

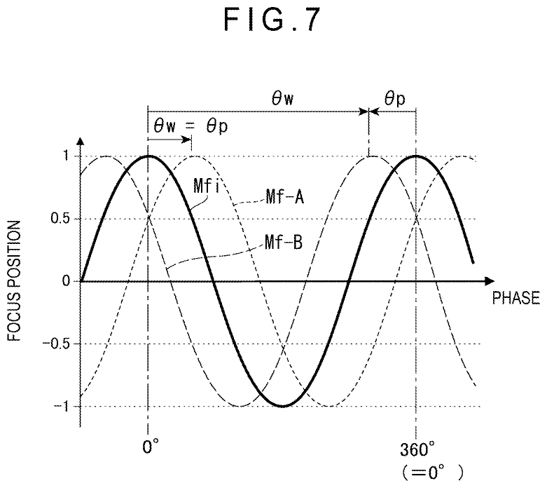

The image detection method according to the present exemplary embodiment will be described below with reference to a flowchart in FIG. 6 and graphs in FIGS. 7 to 13. It should be noted that an instance, where m+1 detection phases θdₙ (n=0, 1, 2 . . . m) are set and images I (image group) corresponding to respective detection phases θdₙ are detected, will be described below. Further, ordinate axes in FIGS. 7 to 13 each represent the detection focus position Hd in the variable range Rh of the focus position H (−1.0≤Rh≤1.0).

Initially, the lens control unit 6 stores, in the storage 64, the phase width θw, the number of pitches m, and a detection range (upper limit ratio Pt, lower limit ratio Pb) that are acquired from the controller 7 (Step S1). The phase width θw is a value calculated from the above-described calibration data. The number of pitches m, the upper limit ratio Pt, and the lower limit ratio Pb are values inputted through, for instance, the operation interface 74.

It should be noted that the number of pitches m represents the number of pitches between the detection focus positions Hdₙ (n=0, 1, 2 . . . m) in the Z axis. The detection range, which is a part of the variable range Rh of the focus position H provided with the detection focus positions Hdₙ, is defined by the upper limit ratio Pt and the lower limit ratio Pb. The upper limit ratio Pt is set at a desired value in a range of 0<Pt≤1.0. The lower limit ratio Pb is set at a desired value in a range of −1.0≤Pb<0.

Subsequently, the range determination unit 621 determines whether the phase delay of the variation waveform Mf of the drive signal Cf is positively or negatively delayed based on the phase width θw acquired in Step S1. Then, based on the determination result, the range determination unit 621 determines the designated allowable range Wd of the detection phase θdₙ (Step S2; range determination step).

FIG. 7 is a graph showing the phase delay of the variation waveform Mf of the drive signal Cf. In FIG. 7, a variation waveform Mf-A and a variation waveform Mf-B are respectively positively delayed (positive phase delay) and negatively delayed (negative phase delay) with respect to the ideal waveform Mfi.

The phase width θw of the variation waveform Mf-A from the cycle start phase (0°) of the drive signal Cf to the positive peak of the variation waveform Mf-A is in a range of 0°≤θw≤180°.

In contrast, the phase width θw of the variation waveform Mf-B from the cycle start phase (0°) of the drive signal Cf to the positive peak of the variation waveform Mf-B is in a range of 180°≤θw≤360°.

It should be noted that the angle (delay angle θp) corresponding to the phase delay in the present exemplary embodiment is θp=θw in the case of the positive delay and θp=−(360°−θw) in the case of the negative delay.

In Step S2, the range determination unit 621 determines that the variation waveform is positively delayed when the phase width θw is in a range of 0°≤θw≤180° and sets a first half of the cycle of the drive signal Cf as the designated allowable range Wd (e.g. the range from 0° to 180°) (see FIG. 8).

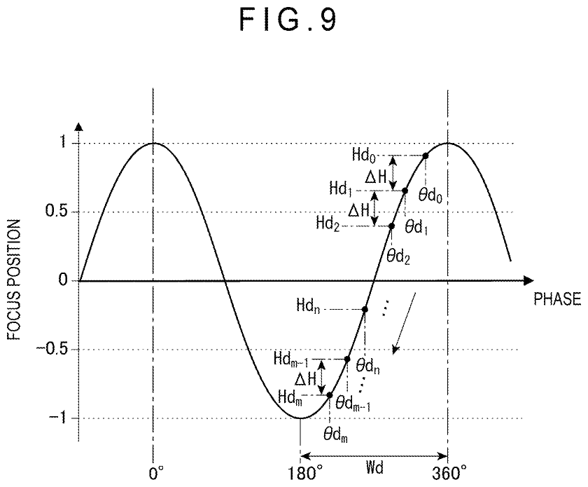

In contrast, the range determination unit 621 determines that the variation waveform is negatively delayed when the phase width θw is in a range of 180°<θw<360° and sets a second half of the cycle of the drive signal Cf as the designated allowable range Wd (e.g. the range from 180° to 360°) (see FIG. 9).

It should be noted that FIGS. 8 and 9 each show an example of the ideal waveform Mfi of the focus position H.

Subsequently, the detection phase setting unit 622 sets a start phase θd₀ and an end phase θdₘ related to the detection phase θdₙ of the drive signal Cf for the designated allowable range Wd (Step S3).

For instance, when the designated allowable range Wd is the first half of the cycle of the drive signal Cf (i.e. the positive delay; see FIG. 8), the start phase θd₀ and the end phase θdₘ are respectively calculated by formulae (1) and (2) below.

$$\begin{matrix}θ {d}_{0} = \frac{\text{?}}{\text{?}} \times {cos}^{- 1} ( 1 \cdot Pt ) & Formula ( 1 ) \\ θ {d}_{m} = \frac{\text{?}}{\text{?}} \times {cos}^{- 1} ( - 1 \cdot Pb ) \\ \text{?} \text{indicates text missing or illegible when filed} & Formula ( 2 )\end{matrix}$$

In contrast, when the designated allowable range Wd is the second half of the cycle of the drive signal Cf (i.e. the negative delay; see FIG. 9), the start phase θd₀ and the end phase θdₘ are respectively calculated by formulae (3) and (4) below.

$$\begin{matrix}θ {d}_{0} = 360 - \frac{\text{?}}{\text{?}} \times {cos}^{- 1} ( 1 \cdot Pt ) & Formula ( 3 ) \\ θ {d}_{m} = 360 - \frac{\text{?}}{\text{?}} \times {cos}^{- 1} ( - 1 \cdot Pb ) \\ \text{?} \text{indicates text missing or illegible when filed} & Formula ( 4 )\end{matrix}$$

It should be noted that Pt and Pb respectively represent the upper limit ratio and the lower limit ratio of the detection range acquired in Step S1.

Subsequently, the detection phase setting unit 622 calculates a detection pitch ΔH, which is a pitch between the detection focus positions Hdₙ that are adjacent to each other in the direction of the Z axis (Step S4). The detection pitch ΔH is calculated according to formulae (5) to (7) below. It should be noted that, in the formulae (5) to (7) below, Hd₀ and Hdₘ are the detection focus positions Hd corresponding to the start phase θd₀ and the end phase θdₘ, respectively.

$$\begin{matrix}{Hd}_{0} = cos θ {d}_{0} & Formula ( 5 ) \\ {Hd}_{m} = cos θ {d}_{m} & Formula ( 6 ) \\ Δ H = \frac{{Hd}_{0} - {Hd}_{m}}{m} & Formula ( 7 )\end{matrix}$$

Subsequently, the detection phase setting unit 622 calculates the detection phases θdₙ corresponding to the detection focus positions Hdₙ (Step S5). Each of the detection phases θdₙ is calculated according to formulae (8) to (9) below.

$$\begin{matrix}{Hd}_{m} = {Hd}_{0} - n Δ H & Formula ( 8 ) \\ θ {d}_{n} = {cos}^{- 1} {Hd}_{n} = {cos}^{- 1} \{ cos θ {d}_{0} - \frac{n ( cos θ {d}_{0} - cos θ {d}_{m} )}{m} \} & Formula ( 9 )\end{matrix}$$

The detection phases θdₙ (n=0, 1, 2 . . . m) as shown in FIG. 8 or 9 are set through the above-described Steps S3 to S5 and are stored in the storage 64 (detection phase setting step).

Then, the detection control unit 623 calculates the number of delay clocks Wcₙ (n=0, 1, 2 . . . m) (Step S6). It should be noted that the number of delay clocks Wcₙ is the number of clocks of a clock signal in the lens control unit 6, which is used to designate timings offset from the detection phases θdₙ by a period corresponding to the delay angle θp.

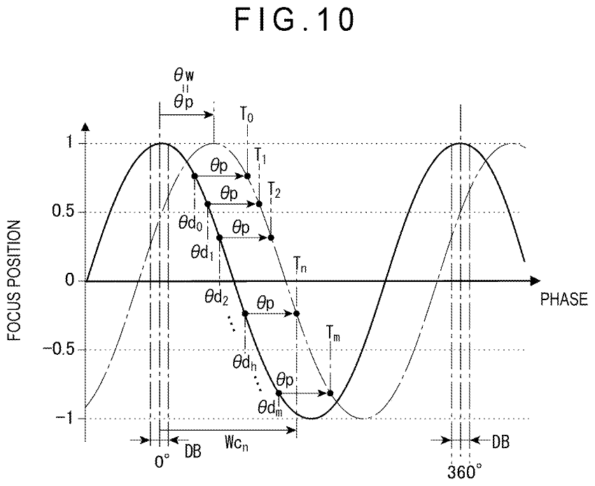

For instance, when the first half of the cycle of the drive signal Cf is set as the designated allowable range Wd (the positive delay; see FIG. 10), the number of delay clocks Wcₙ is calculated by a formula (10) below.

$${Wc}_{n} = \frac{{θ}_{w} \frac{\text{?}}{\text{?}} + θ {d}_{n}}{2 \text{?} F \text{?} Ft} \\ \text{?} \text{indicates text missing or illegible when filed} \qquad Formula ( 10 )$$

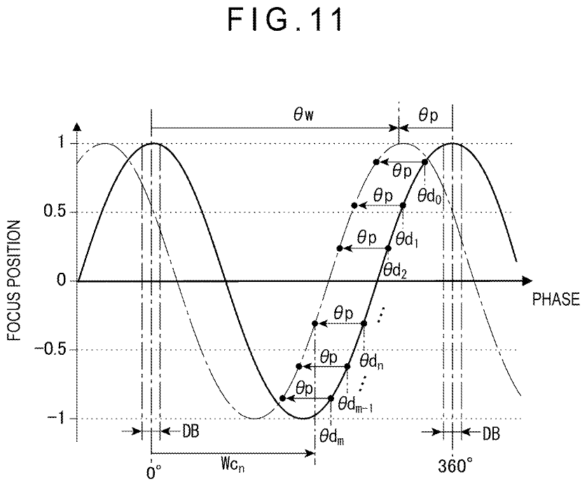

In contrast, when the second half of the cycle of the drive signal Cf is set as the designated allowable range Wd (the negative delay; see FIG. 11), the number of delay clocks Wcₙ is calculated by a formula (11) below.

$${Wc}_{n} = \frac{{θ}_{w} \frac{\text{?}}{\text{?}} θ {d}_{m}}{2 \text{?} F \text{?} Ft} \\ \text{?} \text{indicates text missing or illegible when filed} \qquad Formula ( 11 )$$

It should be noted that Fc and Ft in the above formulae (10) and (11) represent the frequency [Hz] of the clock signal and the frequency [Hz] of the drive signal Cf, respectively. It is assumed that the frequency of the clock signal is sufficiently higher than the frequency of the drive signal Cf.

It should also be noted that FIGS. 10 and 11 each show the ideal waveform Mfi of the focus position H calculated based on the drive signal Cf and an actual phase-delayed variation waveform Mf in a solid line and a dashed line, respectively.

Subsequently, the detection control unit 623 and the image-capturing control unit 63 perform image detection control for detecting the images Iₙ corresponding to the respective detection focus positions Hdₙ (Step S7; detection control step).

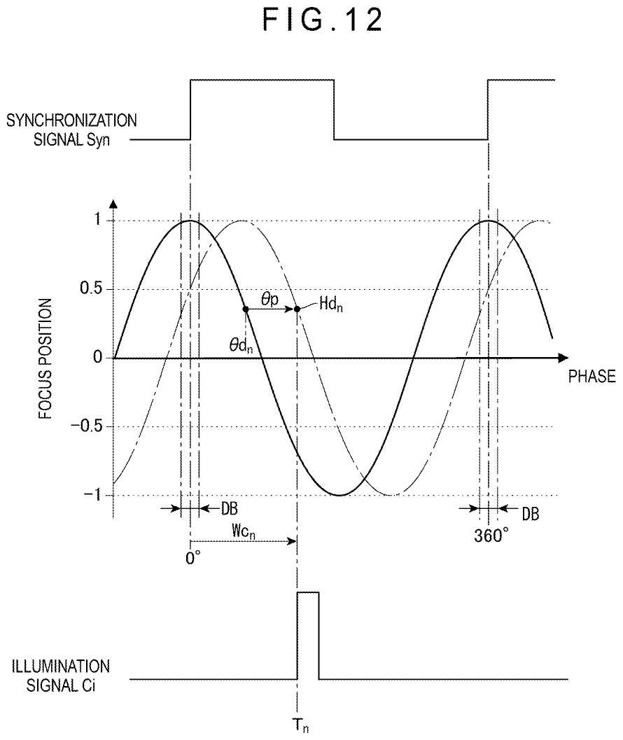

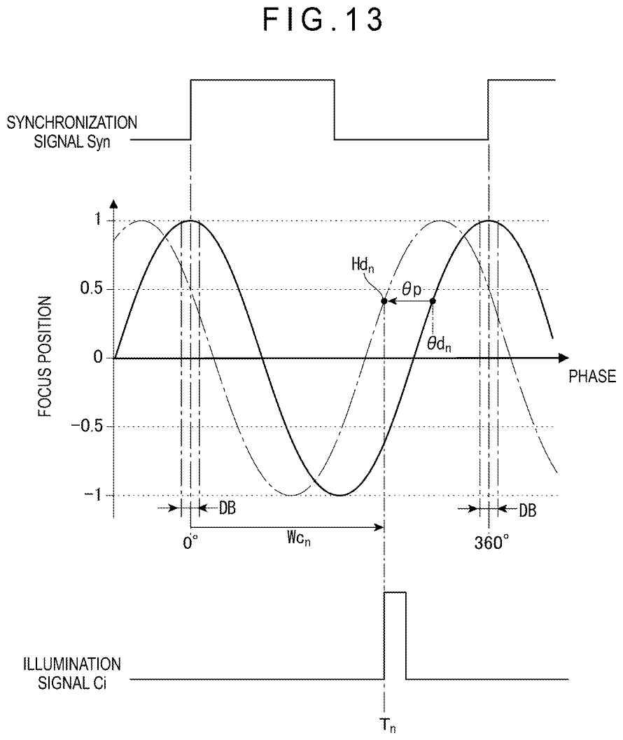

For instance, the detection control unit 623 switches the illumination signal Ci on at a timing at which the drive signal Cf is advanced forward from the cycle start phase (0°) by the number of delay clocks Wcₙ. Thus, the pulsed light illuminator 3 applies the pulsed illumination at a timing (image-detection timing Tₙ) where the delay angle θp is reflected on the detection phase θds (see FIG. 12 or 13). Further, the image-capturing control unit 63 keeps the image capturing unit 4 to be exposed while a predetermined number of pulsed illumination is applied.

In Step S7, the above-described control process is repeatedly performed from n=0 to n=m. Consequently, the images Iₙ (image group) focused at respective detection focus positions Hdₙ (n=0, 1, 2 . . . m) are detected.

The process shown by the flowchart in FIG. 6 is thus ended.

Subsequently, the analyzing unit 73 analyzes the image group detected by the above-described image detection method to measure a height of a target portion and/or a surface profile of the workpiece W. It should be noted that the measurement method, which is the same as that in the related art, will not be described herein.

### Advantage(s) of Exemplary Embodiment

The present exemplary embodiment, in which the image-detection timing T corresponding to the detection phase θd is corrected in consideration of the phase delay of the variation waveform Mf of the focus position H, allows accurate detection of the image assumed at the detection phase θd. Further, in the present exemplary embodiment, since the detection phase θd is set in the designated allowable range Wd determined based on whether the phase delay is positive or negative, the image-detection timing T corrected by reflecting the phase delay on the detection phase θd is not located in an area close to the cycle switching point (360°) of the drive signal Cf (see FIG. 10 or 11).

A phase range DB, in which it is difficult to normally detect the image I, is present in the area close to the cycle switching point of the drive signal Cf. The phase range DB is a predetermined phase range including the cycle switching point. For instance, the width of the phase range DB in a part before the cycle switching point is substantially the same as the pulse width of the illumination signal Ci. In contrast, the width of the phase range DB in a part after the cycle switching point is substantially the same as the period required to switch off the illumination signal Ci.

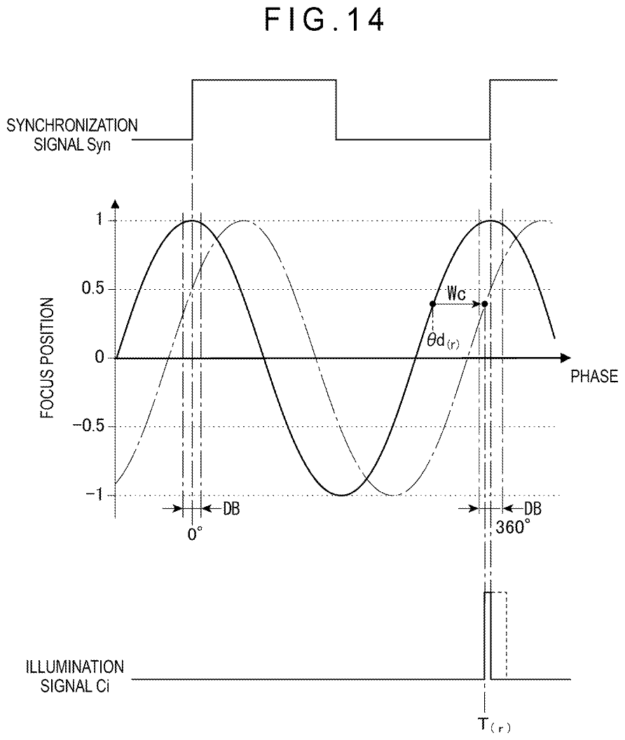

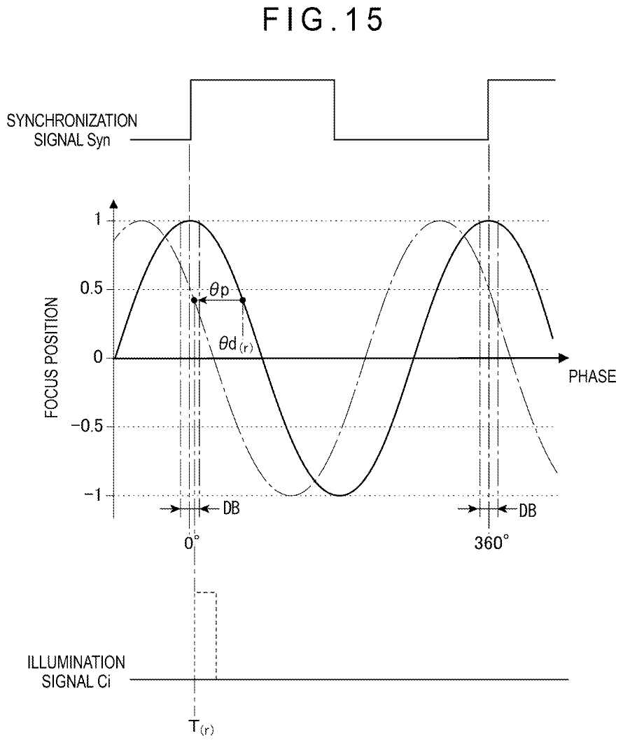

FIGS. 14 and 15 are graphs showing comparative examples of the present exemplary embodiment.

FIG. 14 shows a comparative example, in which the detection phase θd(r) is set in the second half of the cycle of the drive signal Cf while the variation waveform Mf of the focus position H is positively delayed. In this comparative example, since the image-detection timing T(r) is located at a period in the phase range DB before the cycle switching point and the illumination signal Ci is forcibly switched off at the cycle switching point, a pulse width of the illumination signal Ci becomes insufficient to cause uneven illumination, thereby failing to normally detect the image I.

FIG. 15 shows another comparative example, in which the detection phase θd(r) is set in the first half of the cycle of the drive signal Cf while the phase width θw is negatively delayed. In this comparative example, since the image-detection timing T(r) is located at a period in the phase range DB immediately after the cycle switching point, the illumination signal Ci cannot be switched on, possibly causing failure in controlling the image-detection timing T(r).

As compared with the above-described comparative examples, the image-detection timing T of the present exemplary embodiment is not located in the period close to the cycle switching point of the drive signal Cf (i.e. not located in the phase range DB, in which the normal detection of the image I is difficult). Accordingly, normal detection of the image I can be reliably performed in the present exemplary embodiment.

Further, an instance is described in the present exemplary embodiment, where a plurality of images I are detected (image group) while monotonically varying the detection focus position Hdₙ (n=0, 1, 2 . . . m). In this case, since the first half or the second half of the cycle of the drive signal Cf is determined as the designated allowable range Wd depending on whether the phase delay is negative or positive, a broader phase range not overlapping the phase range DB and allowing the monotonic variation in the detection focus position Hdₙ can be secured as the detection range.

In the present exemplary embodiment, a plurality of detection focus positions Hdₙ (n=0, 1, 2 . . . m) located at equal intervals in the variable range Rh of the focus position H are calculated and the phase of the drive signal Cf corresponding to each of the detection focus positions Hdₙ is determined as the detection phase θdₙ (n=0, 1, 2 . . . m). The image-detection timing Tₙ is controlled based on the detection phase θdₙ to detect the image group with even pitch between the detection focus positions Hdₙ.

The pitch between the detection focus positions, which is typically uneven because the image is detected at equal phase intervals, is thus equalized in the present exemplary embodiment, thereby allowing more highly accurate measurement of the displacement, surface profile and the like of the workpiece W.

### Modifications

The invention is not limited to the above-described exemplary embodiment but includes modifications and the like as long as such modifications and the like are compatible with an object of the invention.

For instance, in the exemplary embodiment, the detection focus positions Hd are located at equal intervals in the variable range Rh of the focus position H and the detection phase θd is determined based on each of the detection focus positions Hd. However, the invention is not necessarily configured as in the exemplary embodiment. Specifically, the plurality of detection phases θd may be located at desired intervals (e.g. at equal phase intervals) in the exemplary embodiment.

Although a plurality of detection phases θd are set in order to detect a series of image groups in the exemplary embodiment, the invention is applicable for the purpose of setting a single detection phase θd. For instance, after determining the designated allowable range Wd in the above-described Step S2, at least one detection phase θd may be set in the designated allowable range Wd.

In the invention, in place of the range determination unit 621, the analyzing unit 73 may determine whether the phase delay is positive or negative based on the phase width θw and provide the determination result to the range determination unit 621.

In the exemplary embodiment, the pulsed illumination is used in order to detect the image I corresponding to the detection phase θd. However, the invention is not necessary to be configured as in the exemplary embodiment.

For instance, a continuous illuminator may be used in place of the pulsed light illuminator 3 in a modification. In the modification, the image capturing unit 4, which includes a high-speed shutter capable of providing an extremely short exposure time, is exposed at the image-detection timing T, thereby detecting the image I corresponding to the detection phase θd. In the modification, the image-capturing control unit 63 serves as the range determination unit, the detection phase setting unit, and the detection control unit of the invention in place of the illumination control unit 62.

What is claimed is:

1. An image detection device comprising:
an image detection optical system comprising a liquid resonant lens, a focus position of the image detection optical system cyclically varying in accordance with a drive signal inputted to the liquid resonant lens;
an image detector configured to detect an image corresponding to a detection phase of the drive signal through the image detection optical system;
a range determination unit configured to determine a first half or a second half of a cycle of the drive signal as a designated allowable range of the detection phase based on whether a phase delay shown by a variation waveform of the focus position is positive or negative;
a detection phase setting unit configured to set the detection phase in the designated allowable range; and
a detection control unit configured to control an image-detection timing by the image detector to a timing offset from the detection phase by an angle corresponding to the phase delay.

2. The image detection device according to claim 1, wherein the detection phase setting unit is configured to calculate a plurality of detection focus positions located at equal intervals in a variable range of the focus position and set a phase of the drive signal corresponding to each of the detection focus positions as the detection phase.

3. An image detection method performed by an image detection device comprising: an image detection optical system comprising a liquid resonant lens, a focus position of the image detection optical system cyclically varying in accordance with a drive signal inputted into the liquid resonant lens; and an image detector configured to detect an image corresponding to a detection phase of the drive signal through the image detection optical system, the method comprising:
determining a first half or a second half of a cycle of the drive signal as a designated allowable range of the detection phase based on whether a phase delay shown by a variation waveform of the focus position is positive or negative;
setting the detection phase in the designated allowable range; and
controlling an image-detection timing by the image detector to a timing offset from the detection phase by an angle corresponding to the phase delay.
